(19) United States
(12) Patent Application Publication
(10) Pub. No.: US 2026/0070518 A1
(43) Pub. Date: Mar. 12, 2026

(54) PASSIVE EXTERIOR CAMERA CLEANING SYSTEM UTILIZING PRESSURIZED AIR

(71) Applicant: Toyota Motor Engineering & Manufacturing North America, Inc., Plano, TX (US)

(72) Inventors: Jessica A. Okuma, Ypsilanti, MI (US); Kristin M. Zwirlein, Ypsilanti, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/827,485

(22) Filed: Sep. 6, 2024

(51) Int. Cl. B60S 1/56; B60S 1/54; G02B 27/00

(52) U.S. Cl. CPC B60S 1/56; B60S 1/54; G02B 27/0006

(57) ABSTRACT

Methods, systems, and apparatus for an exterior vehicle camera cleaning system include an air inlet configured to be mounted to a vehicle and an air outlet in fluid communication with the air inlet. The air outlet may be configured to direct the flow of air toward an exterior vehicle camera lens to remove debris therefrom. The air inlet may be configured to receive a flow of air from a positive pressure region of the vehicle that is created by a driving motion of the vehicle.

### BACKGROUND

### Field

The present disclosure relates to vehicles having an exterior camera and more particularly to systems and methods for cleaning a vehicle exterior camera lens.

### Description of the Related Art

Some vehicles include vehicle camera devices mounted on the front and/or rear of the vehicle. Vehicle camera devices installed on the front of the vehicle allow for a driver to observe and record the front direction. Vehicle camera devices installed on the rear of the vehicle allow for a driver to observe and record the rear direction. Vehicle camera devices are installed in various locations of the vehicle to allow for a driver to observe and record various directions. Various driving and environmental conditions (e.g., moisture, dust, road debris, etc.) can lead to moisture, dust, and/or debris adhering to the lens of the vehicle camera. When the residue adheres to the lens of the vehicle camera, the quality of the view provided by the vehicle camera can diminish and/or be obstructed.

Accordingly, it is desirable to provide systems, methods, and techniques for maintaining a clean vehicle camera lens.

### SUMMARY

One aspect of the subject matter described in this disclosure may be embodied in an exterior camera cleaning system or apparatus for a vehicle. The exterior camera cleaning system includes an air inlet configured to be mounted to the vehicle and an air outlet in fluid communication with the air inlet. The air inlet is configured to receive a flow of air from a positive pressure region of the vehicle that is created by a driving motion of the vehicle. The air outlet is configured to direct the flow of air toward an exterior vehicle camera lens for removing a debris from the exterior vehicle camera lens.

In one aspect, the subject matter may be embodied in an exterior camera cleaning system for a vehicle, the exterior camera cleaning system including an air cowl configured to be mounted relative to an exterior vehicle camera. A channel is disposed in the air cowl. The channel can have an air inlet configured to receive a flow of air and an outlet in fluid communication with the air inlet and configured to direct the flow of air toward a lens of the exterior vehicle camera.

In another aspect, the subject matter may be embodied in a method for cleaning an exterior vehicle camera. The method includes receiving a flow of air from a positive pressure region of a vehicle that is created by a driving motion of the vehicle. The method includes directing the flow of air from the positive pressure region of the vehicle toward a lens of the exterior vehicle camera. The method includes removing a debris from the lens in response to the flow of air being directed toward the lens.

These and other embodiments may optionally include one or more of the following features.

The air outlet can include a nozzle that directs the flow of air across the exterior vehicle camera lens.

The exterior camera cleaning system can further include a conduit extending between the air inlet and the air outlet. The conduit is configured to direct the flow of air from the air inlet to the air outlet.

The air inlet can be configured to be located at a front half of the vehicle. The air outlet can be configured to be located at the front half of the vehicle. The air inlet can be configured to be located at a front cowl of the vehicle. The air inlet can be configured to be located at a front fascia of the vehicle. The exterior vehicle camera lens can be located at a rear half of the vehicle.

The air cowl can further include a camera aperture configured to accommodate the exterior vehicle camera.

The exterior camera cleaning system can further include a support bracket configured to support the exterior vehicle camera, and the air cowl is configured to be mounted to the support bracket.

The exterior camera cleaning system can further include an air aperture disposed in the support bracket, and the air inlet is configured to receive the flow of air via the air aperture.

The support bracket can include a pair of opposing flanges, and the air cowl is mounted to the support bracket via the pair of opposing flanges.

The channel can be substantially L-shaped.

Removing the debris from the lens can include blowing away the debris with the flow of air. Removing the debris from the lens can include translating a lens cleaning arm with respect to the lens using the flow of air. Removing the debris from the lens can include rotating a lens cleaning arm with respect to the lens using the flow of air.

The flow of air can be received into an inlet of a conduit, the inlet is located at a front half of the vehicle.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A and FIG. 1B are schematic side views of a vehicle that is stationary and in motion, respectively, according to an aspect of the invention.

FIG. 2 is a schematic view of a vehicle exterior camera lens cleaning system, according to an aspect of the invention.

FIG. 3A, FIG. 3B, FIG. 3C, and FIG. 3D are schematic side views of a vehicle exterior camera lens cleaning system installed on a vehicle and having air inlets installed at different locations of the vehicle, according to an aspect of the invention.

FIG. 4A, FIG. 4B, and FIG. 4C are schematic side, front, and rear views, respectively, showing various locations for installing an air inlet and/or an exterior camera on a vehicle, according to an aspect of the invention.

FIG. 5A is a perspective view of an exterior camera installed on a support bracket of a vehicle, according to an aspect of the invention.

FIG. 5B is a perspective view of an air cowl of an exterior camera lens cleaning system installed with respect to the exterior camera of FIG. 5A, according to an aspect of the invention.

FIG. 5C is a section view of the exterior camera lens cleaning system of FIG. 5B, according to an aspect of the invention.

FIG. 6 is a schematic view of an exterior camera lens cleaning system having a translating lens cleaning arm, according to an aspect of the invention.

FIG. 7 is a schematic view of an exterior camera lens cleaning system having a pivoting lens cleaning arm, according to an aspect of the invention.

### DETAILED DESCRIPTION

Disclosed herein are systems, methods, devices, and/or vehicles for implementing a passive vehicle camera lens cleaning system. Aspects and/or embodiments are directed to providing a pressurized flow of air directed at an exterior vehicle camera lens to blow away debris accumulated on the exterior vehicle camera lens and/or to prevent debris from accumulating on the exterior vehicle camera lens. A passive vehicle camera lens cleaning system may minimize the frequency the exterior camera lens requires cleaning, which can contribute to fewer instances where the driver may not have full peripheral/rearward (depending on the field of view of the exterior camera) awareness due to blind spots from dirtiness on the lens. A passive vehicle camera lens cleaning system may be designed to operate without any additional fluids or maintenance indefinitely.

The passive vehicle camera lens cleaning system can include a camera lens located at a negative pressure location and a duct routed from a positive pressure location during a driving condition of the vehicle. A flow of air is directed from the positive pressure location to the negative pressure location and directed to flow across the camera lens to blow debris away from the camera lens to minimize any dust/dirt/condensation accumulation. By utilizing a duct, the camera is not required to be placed in any specific airstream path. For example, a duct can extend from the base of the front windshield (cowl area) to a nozzle facing the camera lens. However, as described herein, the duct can be placed at various locations.

As used herein, the term “negative pressure” refers to a pressure that is lower than the pressure of the surrounding environment.

As used herein, the term “positive pressure” refers to a pressure that is greater than the pressure of the surrounding environment.

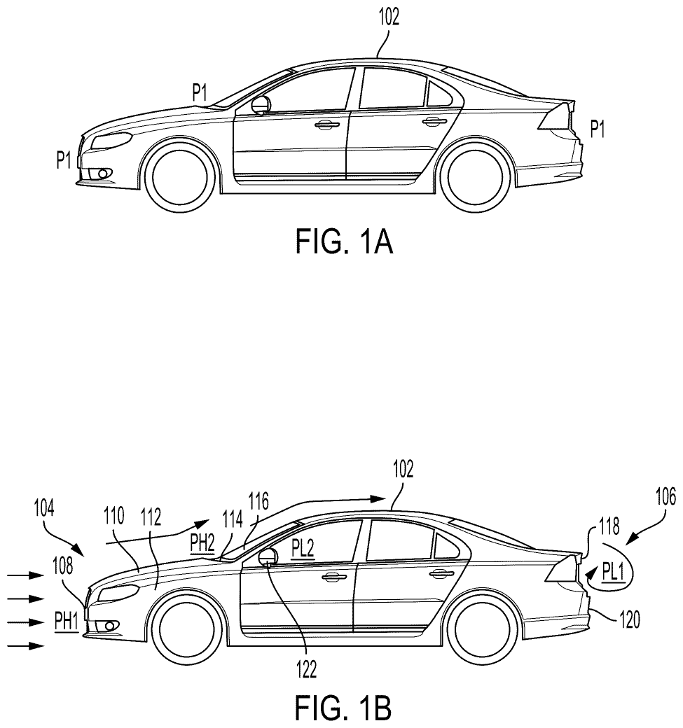

FIG. 1A and FIG. 1B are side views of a vehicle 102 that is stationary (FIG. 1A) and while driving (FIG. 1B). The vehicle 102 may be a self-propelled wheeled conveyance, such as a car, a sport utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of electric/hybrid vehicle. Other examples of vehicles include bicycles, trains, planes, or boats, and any other form of conveyance that is capable of transportation. The vehicle 102 may be semi-autonomous or autonomous.

While stationary (i.e., not moving relative to a ground surface), the pressure P1 around the vehicle 102 is substantially equal. While the vehicle 102 is driving (i.e., moving relative to a ground surface), the pressure around the vehicle 102 varies. In general, and due to aerodynamics of the vehicle 102, air pressure near forward facings surfaces of the vehicle 102 can be greater than the surrounding air pressure and air pressure near rearward facing surfaces of the vehicle 102 can be less than the surrounding air pressure. In various aspects, the pressure at the front end 104 of the vehicle 102 can be greater than the surrounding air pressure. In various aspects, the pressure at the rear end 106 of the vehicle 102 can be less than the surrounding air pressure.

In various aspects, a first pressure PH1 can be generated at the front fascia 108 of the vehicle 102 while the vehicle 102 is in motion. The front fascia 108 is generally located forward of the hood 110 and quarter panels 112. The front fascia 108 generally includes the front grille and a front bumper. For vehicles 102 with an engine compartment, the front fascia 108 can define an opening to the engine compartment to allow airflow into the air induction system and for cooling of the engine compartment. For vehicles 102 with a front trunk, the front fascia 108 can be sealed from the compartment to prevent foreign objects (e.g., debris and moisture) from entering the compartment. The front fascia 108 may be designed for vehicle styling and aesthetic appeal and may also include the vehicle manufacturer logo or may have ornamental design characteristics.

A second pressure PH2 can be generated at the hood cowl 114 of the vehicle 102. The hood cowl 114 can be located between the lower edge of the front windshield 116 and the rear edge of the hood 110. The first pressure PH1 and the second pressure PH2 can be positive pressures.

A third pressure PL1 can be generated at the rear end 106 of the vehicle 102. The rear end of the vehicle 102 can generally include a rear hatch or door 118 and a rear bumper 120. The driving motion of the vehicle 102 can cause rear end suction, also known as flow detachment, when the air passing around the vehicle 102 cannot fill the space left behind, creating a negative pressure. The rear end 106 of the vehicle 102 can fill with negative pressure, creating a wake region that increases the vehicle's drag force by sucking against its forward motion.

A fourth pressure PL2 can be generated just aft of the sideview mirrors 122. The driving motion of the vehicle 102 can cause sideview mirror suction, also known as flow detachment, when the air passing around the sideview mirrors 122 cannot fill the space left behind, creating a negative pressure. In contrast to the negative pressure PL2 just aft of the sideview mirrors 122, positive pressure can be generated just forward of the sideview mirrors 122.

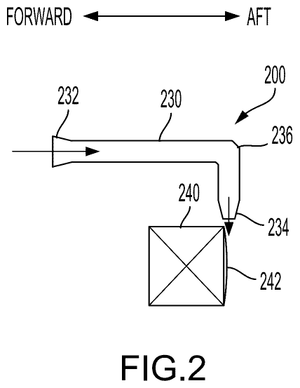

FIG. 2 is a schematic view of a vehicle exterior camera cleaning system 200 in accordance with various aspects. The cleaning system 200 generally includes a conduit 230 configured to direct a flow of air, depicted by arrows in FIG. 2, across a camera lens 242 of an exterior camera 240. The conduit 230 can include an inlet 232 configured to receive the flow of air. The inlet 232 can be a ram-air inlet in various aspects. In various aspects, the flow of air is induced in response to the air pressure differential between the air inlet 232 and the air outlet 234. The inlet 232 can face a forward direction when installed on a vehicle in various aspects. The conduit 230 can further include an air outlet 234. The conduit 230 can include one or more bends 236 between the air inlet 232 and the air outlet 234. The air outlet 234 can be positioned with respect to the camera lens 242. The air outlet 234 can be configured to direct the flow of air across the camera lens 242. The air outlet 234 can be a nozzle that directs the flow of air across the camera lens 242. For example, the air outlet 234 can converge to focus the flow of air across the camera lens 242.

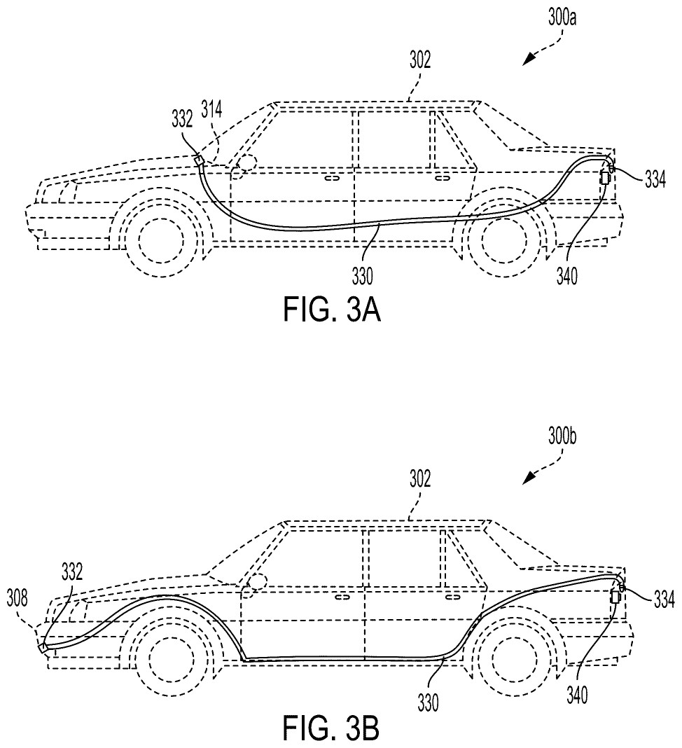

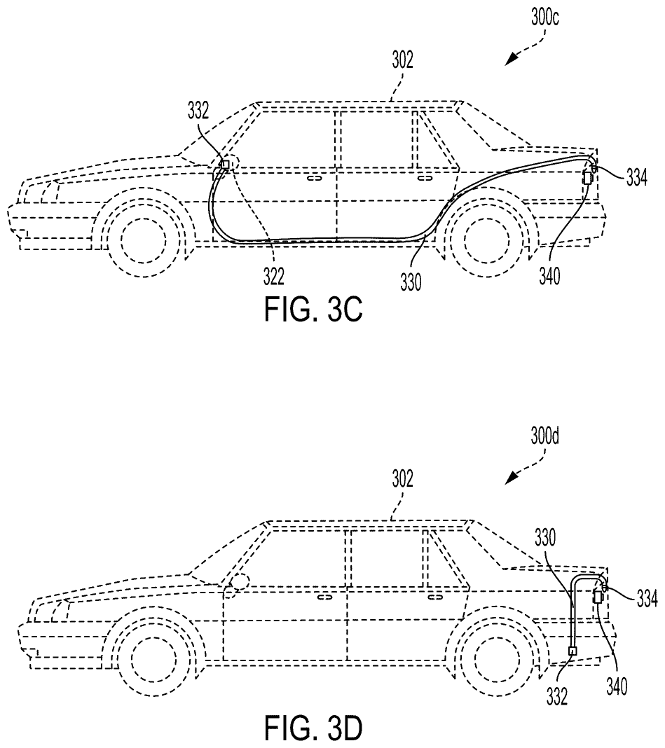

FIG. 3A is a schematic view of a vehicle exterior camera cleaning system 300 installed on a vehicle 302. In various aspects, the cleaning system 300 can be similar to the cleaning system 200 of FIG. 2. The cleaning system 300 can include a conduit 330 having an inlet 332 and an outlet 334 configured to direct a flow of air to an exterior camera 340. The exterior camera 340 can be installed at a rear of the vehicle 302 as a rear-view camera. In various aspects, the inlet 332 is installed at the front cowl 314 of the vehicle 302 as depicted in FIG. 3A. In various aspects, the inlet 332 is installed at the front fascia 308 of the vehicle 302 as depicted in FIG. 3B. The inlet 332 can be located at the front bumper or the front grille of the front fascia 308 of the vehicle 302. In various aspects, the inlet 332 is installed at the front of the sideview mirror 322 of the vehicle 302 as depicted in FIG. 3C. In various aspects, the inlet 332 is installed at the underside of the vehicle 302 as depicted in FIG. 3D. For example, the inlet 332 can be configured to be in a location underneath the vehicle 302 that receives a flow of air when the vehicle 302 is in motion. The inlet 332 can be located aft of the rear wheels of the vehicle 302. As illustrated in each of FIG. 3A through FIG. 3D, the inlet 332 of the cleaning system 300 can be located at a positive pressure area of the vehicle 302 so that a flow of air is induced through the conduit 330 while the vehicle 302 is driving. As illustrated in each of FIG. 3A through FIG. 3C, the inlet 332 of the cleaning system 300 can be located at a front half of the vehicle 302. As illustrated in FIG. 3D, the inlet 332 of the cleaning system 300 can be located at a rear half of the vehicle 302.

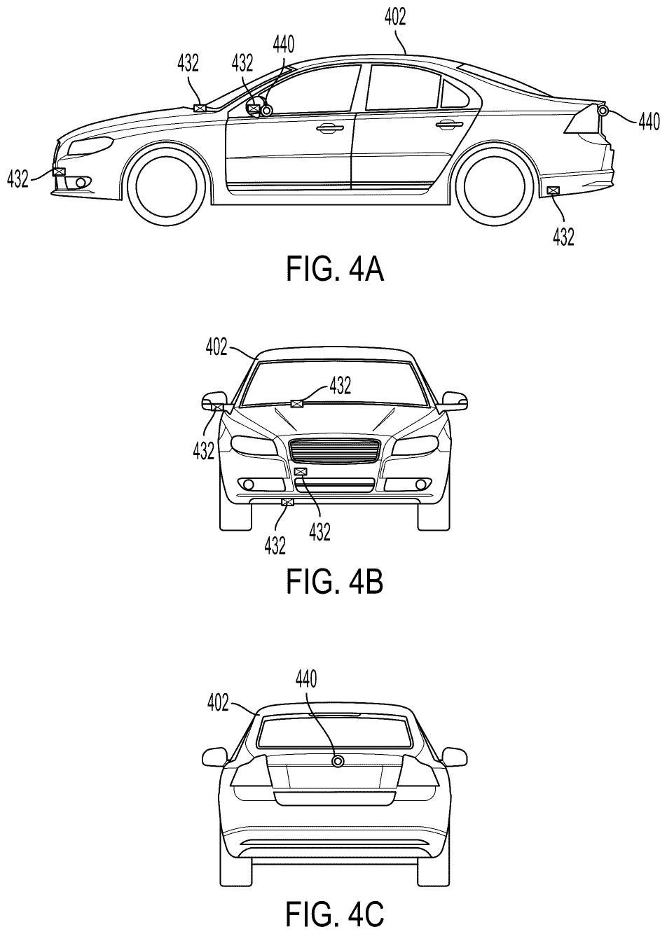

In various aspects, FIG. 4A, FIG. 4B, and FIG. 4C are side, front, and rear views of locations on a vehicle 402 for installing the air inlet 432 of the camera cleaning system and/or the exterior camera 440 of the camera cleaning system. The exterior camera 440 can be installed at any of the locations indicated in FIG. 4A through FIG. 4C (e.g., the sideview mirrors, the rear of the vehicle 402) or any other suitable location. The air inlet 432 can be installed at any of the locations indicated in FIG. 4A through FIG. 4C (e.g., the front fascia of the vehicle 402, the front cowl of the vehicle 402, the sideview mirrors, the underside of the vehicle 402) or any other suitable location. In this regard, the exterior camera 440 and the air outlet of the camera cleaning system can both be at the front half of the vehicle 402 in various aspects. The exterior camera 440 and the air outlet of the camera cleaning system can both be at the rear half of the vehicle 402 in various aspects. The exterior camera 440 can be at the rear half of the vehicle 402 and the air inlet 432 of the camera cleaning system can be at the front half of the vehicle 402 in various aspects. In various aspects, it can be desirable for the exterior camera 440 to be located at a negative pressure location when the vehicle 402 is in motion and the air inlet 432 to be located at a positive pressure location when the vehicle 402 is in motion to facilitate air flow through from the air inlet to the air outlet of the conduit of the camera cleaning system.

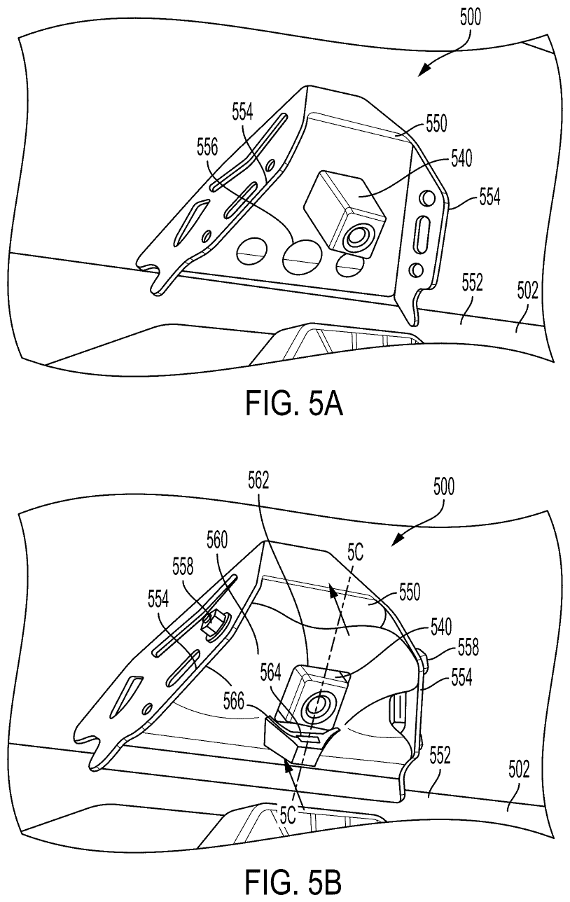

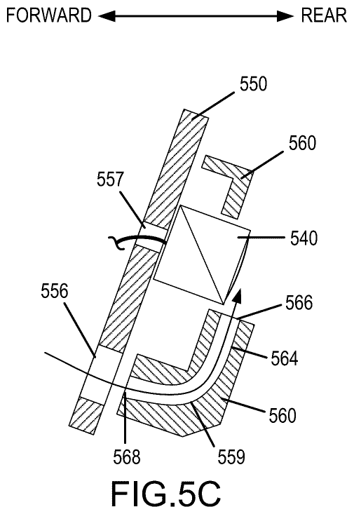

FIG. 5A is a perspective view of an exterior camera 540 mounted to a vehicle 502, in accordance with various aspects. The exterior camera 540 can be mounted to the vehicle 502 via a support bracket 550. In various aspects, the support bracket 550 is mounted to a bumper 552 of the vehicle 502. The bumper 552 can be a rear bumper of the vehicle 502. In this regard, the exterior camera 540 can be a rear-facing camera. The support bracket 550 can include a pair of opposing flanges 554. An air aperture 556 can be disposed in the support bracket 550. The air aperture 556 can be located between the opposing flanges 554.

FIG. 5B is a perspective view of the exterior camera 540 mounted to the vehicle 502 with an exterior camera cleaning system 500 installed, in accordance with various aspects. The camera cleaning system 500 generally includes an air cowl 560 configured to be mounted relative to the exterior vehicle camera 540. The air cowl 560 can be mounted to the support bracket 550. The air cowl can be coupled to the pair of opposing flanges 554 via a pair of fasteners 558.

The air cowl 560 can include an aperture 562 (also referred to herein as a camera aperture) configured to receive the exterior camera 540. The exterior camera 540 can extend through the aperture 562. The air cowl 560 can include a channel 564 configured to direct a flow of air toward a lens of the exterior camera 540. An outlet 566 of the channel 564 can be located at the exterior camera 540. In various aspects, the outlet 566 is oriented generally perpendicular (e.g., 90 degrees plus or minus 20 degrees) to the aperture 562.

FIG. 5C is a section view of the exterior camera cleaning system 500 of FIG. 5B. The channel 564 can include an air inlet 568 configured to receive a flow of air while the vehicle 502 is driving. The air inlet 568 can be a ram-air inlet. The air inlet 568 can be aligned with the air aperture 556 so that air flows through the air aperture 556 and into the air inlet 568. The channel 564 can include one or more bends 559 located between the inlet 568 and the outlet 566 to redirect a direction of the flow of air. In various aspects, the channel 564 is substantially L-shaped as illustrated in FIG. 5C. In various aspects, the exterior camera 540 can be tilted slightly downwards and the air outlet 566 is located below the exterior camera 540.

In various aspects, the bracket 550 further includes an aperture 557 configured to receive one or more wires from the exterior camera 540. The aperture 557 can be partially covered by the exterior camera 540 when the exterior camera 540 is in an installed position.

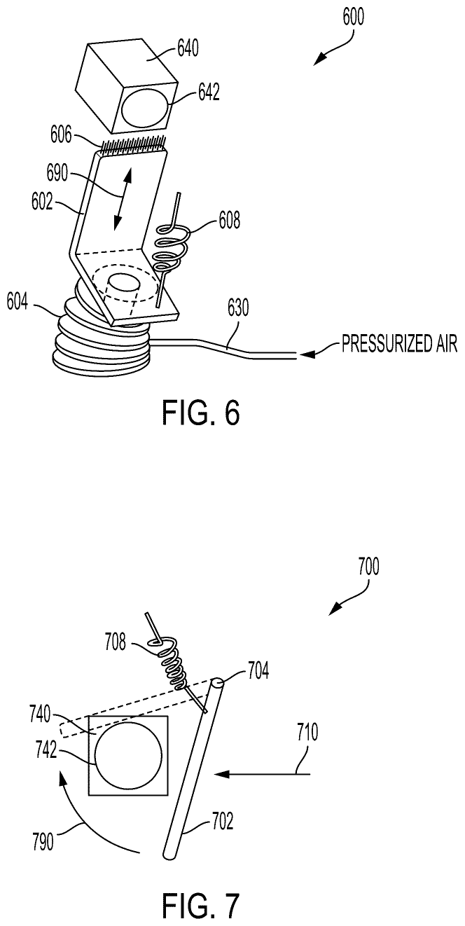

FIG. 6 is an air-powered lens cleaning mechanism 600 for an exterior camera 640. The lens cleaning mechanism 600 can be operated with any of the exterior camera cleaning systems described herein. For example, the lens cleaning mechanism 600 can receive a flow of air from a conduit of cleaning system 200 (see FIG. 2) of any of the cleaning systems depicted in FIG. 3A through FIG. 3D, or the channel of the cleaning system 500 (see FIG. 5B and FIG. 5C).

The lens cleaning mechanism 600 generally includes a translating lens cleaning arm 602 mounted to an air bellows 604. In response to the air bellows 604 receiving pressurized air via the conduit 630, the air bellows 604 moves from a retracted state to an extended state with respect to the camera lens 642, for example along the direction of arrow 690. The lens cleaning arm 602 can include a lens cleaning contact surface 606, such as a brush or squeegee, which contacts the lens 642 to remove any debris accumulated thereon in response to the air bellows 604 moving from the retracted state to the extended state. In various aspects, the lens cleaning mechanism 600 further includes a return spring 608 configured to bias the air bellows 604 to the retracted position so that the camera lens 642 is not obstructed. The return spring 608 can be coupled to the lens cleaning arm 602. The lens cleaning arm 602 can be made of plastic, metal, rubber, or a composite material.

FIG. 7 is an air-powered lens cleaning mechanism 700 for an exterior camera 740. The lens cleaning mechanism 700 can be operated with any of the exterior camera cleaning systems described herein. For example, the lens cleaning mechanism 700 can receive a flow of pressurized air 710 from a conduit of cleaning system 200 (see FIG. 2) of any of the cleaning systems depicted in FIG. 3A through FIG. 3D, or the channel of the cleaning system 500 (see FIG. 5B and FIG. 5C).

The lens cleaning mechanism 700 generally includes a pivoting lens cleaning arm 702 pivotally mounted to a fixed structure 704. In response to the lens cleaning arm 702 receiving pressurized air from the exterior camera cleaning system (e.g., a channel or a conduit), the lens cleaning arm 702 is biased to move from a first rotational position (shown in solid lines in FIG. 7) to a second rotational position (shown in dashed lines in FIG. 7) with respect to the camera lens 742, for example along the direction of arrow 790. The lens cleaning arm 702 can include a lens cleaning contact surface, such as a brush or squeegee, which contacts the lens 742 to remove any debris accumulated thereon in response to the lens cleaning arm 702 moving between the first rotational position and the second rotational position. In various aspects, the lens cleaning mechanism 700 further includes a return spring 708 configured to bias the lens cleaning arm 702 toward the first rotational position so that the lens cleaning arm 702 is automatically reset for the next flow of pressurized air. The lens cleaning arm 702 can clean the lens 742 when moving from the first rotational position to the second rotational position and when moving from the second rotational position to the first rotational position. In various aspects, the lens cleaning arm 702 moves to the second rotational position when the vehicle is moving, and the flow of air overcomes the bias of the return spring 708 to rotate the lens cleaning arm 702 toward the second rotational position. In various aspects, the lens cleaning arm 702 moves to the first rotational position when the vehicle is stopped, or below a predetermined speed, and the return spring 708 biases the lens cleaning arm 702 toward the first rotational position. The return spring 708 can be coupled to the lens cleaning arm 702. The lens cleaning arm 702 can be made of plastic, metal, rubber, or a composite material.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. An exterior camera cleaning system for a vehicle, comprising:
an air inlet configured to be mounted to the vehicle, the air inlet is configured to receive a flow of air from a positive pressure region of the vehicle that is created by a driving motion of the vehicle; and
an air outlet in fluid communication with the air inlet, the air outlet configured to direct the flow of air toward an exterior vehicle camera lens for removing a debris from the exterior vehicle camera lens.

2. The exterior camera cleaning system of claim 1, wherein the air outlet includes a nozzle that directs the flow of air across the exterior vehicle camera lens.

3. The exterior camera cleaning system of claim 1, further comprising a conduit extending between the air inlet and the air outlet and configured to direct the flow of air from the air inlet to the air outlet.

4. The exterior camera cleaning system of claim 3, wherein the air inlet is configured to be located at a front half of the vehicle.

5. The exterior camera cleaning system of claim 4, wherein the exterior vehicle camera lens is located at a rear half of the vehicle.

6. The exterior camera cleaning system of claim 4, wherein the air outlet is configured to be located at the front half of the vehicle.

7. The exterior camera cleaning system of claim 4, wherein the air inlet is configured to be located at a front cowl of the vehicle.

8. The exterior camera cleaning system of claim 4, wherein the air inlet is configured to be located at a front fascia of the vehicle.

9. An exterior camera cleaning system for a vehicle, comprising:
an air cowl configured to be mounted relative to an exterior vehicle camera;
a channel disposed in the air cowl, the channel includes an air inlet configured to receive a flow of air and an outlet in fluid communication with the air inlet and configured to direct the flow of air toward a lens of the exterior vehicle camera.

10. The exterior camera cleaning system of claim 9, wherein the air cowl further includes a camera aperture configured to accommodate the exterior vehicle camera.

11. The exterior camera cleaning system of claim 9, further comprising a support bracket configured to support the exterior vehicle camera, and the air cowl is configured to be mounted to the support bracket.

12. The exterior camera cleaning system of claim 11, further comprising an air aperture disposed in the support bracket, and the air inlet is configured to receive the flow of air via the air aperture.

13. The exterior camera cleaning system of claim 12, wherein the support bracket includes a pair of opposing flanges, and the air cowl is mounted to the support bracket via the pair of opposing flanges.

14. The exterior camera cleaning system of claim 9, wherein the channel is substantially L-shaped.

15. A method for cleaning an exterior vehicle camera, comprising:
receiving a flow of air from a positive pressure region of a vehicle that is created by a driving motion of the vehicle;
directing the flow of air from the positive pressure region of the vehicle toward a lens of the exterior vehicle camera; and
removing a debris from the lens in response to the flow of air being directed toward the lens.

16. The method of claim 15, wherein removing the debris from the lens includes blowing away the debris with the flow of air.

17. The method of claim 15, wherein removing the debris from the lens includes translating a lens cleaning arm with respect to the lens using the flow of air.

18. The method of claim 15, wherein removing the debris from the lens includes rotating a lens cleaning arm with respect to the lens using the flow of air.

19. The method of claim 15, wherein the flow of air is received into an inlet of a conduit, the inlet is located at a front half of the vehicle.

20. The method of claim 19, wherein the exterior vehicle camera is located at a rear half of the vehicle.
